(19) United States
(12) Patent Application Publication
(10) Pub. No.: US 2026/0104701 A1
(43) Pub. Date: Apr. 16, 2026

(54) ROBUST PREDICTIVE MAINTENANCE METHOD FOR MULTIPLE MACHINERIES USING MULTIPLE MICROPHONES

(71) Applicant: HITACHI, Ltd., Tokyo (JP)

(72) Inventor: Akira INOUE, Farmington Hills, MI (US)

(21) Appl. No.: 18/891,738

(22) Filed: Sep. 20, 2024

(51) Int. Cl. G05B 23/02; G01N 29/44

(52) U.S. Cl. CPC G05B 23/0283; G01N 29/44

(57) ABSTRACT

A method for performing predictive maintenance that comprises installing a plurality of sound sensors at a plurality of sound monitoring points for monitoring a plurality of machines; measuring, using the plurality of sound sensors, sound pressure data from the plurality of machines at a first time period; deriving, by a processor, particle velocity data using the sound pressure data; and generating, by the processor, at least one of anomaly score or remaining useful life (RUL) associated with maintenance of the plurality of machines based on the particle velocity data and the sound pressure data, wherein the particle velocity data is derived from the sound pressure data based on distance of the sound sensors, and wherein the sound sensors are microphones.

### BACKGROUND

### Field

The present disclosure is generally directed to sound and/or vibration monitoring for predictive maintenance.

### Related Art

In some industrial environments, vibration and/or sound monitoring is performed to identify possible maintenance issues with a set of monitored machines. For example, the monitoring may be used for a predictive maintenance to predict and plan for machine breakdown to avoid downtime and extra cost resulting from an unexpected machine breakdown. Vibration is typically measured by an accelerometer sensor attached on a monitored machine or structure. Vibration information is good to find detailed conditions of the machine near the sensor. However, vibration information, in some instances, may not be useful for monitoring conditions far from the point where the sensor is attached. For example, vibrations may intentionally be damped across a machine or across different parts of a machine to provide vibrational isolation or may be damped unintentionally by the structure of, or vibrational path through, the machine.

Sound is typically measured by a microphone placed in the vicinity of or around the machine. Sound information is often useful to monitor the overall or primary conditions of a monitored machine. However, acoustic noise in the surrounding is often non-negligible, and disturbs the sound analysis. Therefore, to monitor a machine condition for condition-based or predictive maintenance, it is desirable to use both sound data and vibration data (e.g., complementary data). However, to use both sound and vibration sensors (i.e., a microphone and an accelerometer) may be costly. Additionally, when a microphone is at a node of a standing wave associated with a particular set of frequencies, sound pressure may be zero, or close to zero. At frequencies in the particular set of frequencies, little or no useful acoustic data may be available.

In the related art, a method for performing machine monitoring utilizing full-time sound sensors and vibration sensors is disclosed. Sound can be monitored using full-time sound sensors, while vibration data is collected using full-time vibration sensors. However, utilization of both sound sensors and vibration sensors can be costly and hence not desirable.

In the related art, a method for identifying the highest contributing sound source through beamforming employed by acoustic cameras is disclosed. Vibration sensors and/or sound sensors are used along with the acoustic cameras in identifying contributing sound source. However, the added costs of acoustic cameras make such application unfeasible.

An apparatus and method are presented below to provide the benefits of monitoring both vibration and sound (acoustic) data by performing only direct sound monitoring. Vibration is indirectly estimated by using the directly monitored sound data and pre-measured acoustic transfer function.

### SUMMARY

Aspects of the present disclosure involve an innovative method for performing predictive maintenance. The method may include installing a plurality of sound sensors at a plurality of sound monitoring points for monitoring a plurality of machines; measuring, using the plurality of sound sensors, sound pressure data from the plurality of machines at a first time period; deriving, by a processor, particle velocity data using the sound pressure data; and generating, by the processor, at least one of anomaly score or remaining useful life (RUL) associated with maintenance of the plurality of machines based on the particle velocity data and the sound pressure data, wherein the particle velocity data is derived from the sound pressure data based on distance of the sound sensors, and wherein the sound sensors are microphones.

Aspects of the present disclosure involve an innovative non-transitory computer readable medium, storing instructions for performing predictive maintenance. The instructions may include installing a plurality of sound sensors at a plurality of sound monitoring points for monitoring a plurality of machines; measuring, using the plurality of sound sensors, sound pressure data from the plurality of machines at a first time period; deriving, by a processor, particle velocity data using the sound pressure data; and generating, by the processor, at least one of anomaly score or remaining useful life (RUL) associated with maintenance of the plurality of machines based on the particle velocity data and the sound pressure data, wherein the particle velocity data is derived from the sound pressure data based on distance of the sound sensors, and wherein the sound sensors are microphones.

Aspects of the present disclosure involve an innovative server system for performing predictive maintenance. The server system may include installing a plurality of sound sensors at a plurality of sound monitoring points for monitoring a plurality of machines; measuring, using the plurality of sound sensors, sound pressure data from the plurality of machines at a first time period; deriving, by a processor, particle velocity data using the sound pressure data; and generating, by the processor, at least one of anomaly score or remaining useful life (RUL) associated with maintenance of the plurality of machines based on the particle velocity data and the sound pressure data, wherein the particle velocity data is derived from the sound pressure data based on distance of the sound sensors, and wherein the sound sensors are microphones.

Aspects of the present disclosure involve an innovative system for performing predictive maintenance. The system can include means for installing a plurality of sound sensors at a plurality of sound monitoring points for monitoring a plurality of machines; means for measuring, using the plurality of sound sensors, sound pressure data from the plurality of machines at a first time period; means for deriving particle velocity data using the sound pressure data; and means for generating at least one of anomaly score or remaining useful life (RUL) associated with maintenance of the plurality of machines based on the particle velocity data and the sound pressure data, wherein the particle velocity data is derived from the sound pressure data based on distance of the sound sensors, and wherein the sound sensors are microphones.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example diagram 100 of an environment for performing sound and vibration monitoring, in accordance with an example implementation.

FIG. 2 illustrates an example diagram 200 of an environment for measuring an acoustic transfer function that relates sound (and/or vibration) at a monitored machine to a measured sound (e.g., pressure and/or particle velocity) at a particular point in the environment of the monitored machine, in accordance with an example implementation.

FIG. 3 illustrates an example network 300 with multiple sound sources and sound monitoring points, in accordance with an example implementation.

FIG. 4 illustrates an example diagram 400 for acquiring sound data and using the sound data for performing predictive maintenance, in accordance with an example implementation.

FIG. 5 illustrates an example diagram 500 for acquiring sound data and using the sound data for performing predictive maintenance, in accordance with an example implementation.

FIG. 6 illustrates an example diagram 600 for acquiring sound data and using the sound data for performing predictive maintenance, in accordance with an example implementation.

FIG. 7 illustrates an example diagram 700 for performing sound distinction, in accordance with an example implementation.

FIG. 8 illustrates an example sound source contribution analysis 800, in accordance with an example implementation.

FIG. 9 illustrates an example process flow 900 for performing predictive maintenance, in accordance with an example implementation.

FIG. 10 illustrates a system involving a plurality of sensors, monitors, assets/industrial systems, computing devices, or machines networked to a management apparatus, in accordance with an example implementation.

FIG. 11 illustrates an example computing environment 1100 with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

Example implementations described herein involve an innovative method to utilize measured sound and estimated vibration, to perform monitoring for predictive maintenance. The sound may be monitored directly and the vibration may be monitored indirectly through the monitored sound. The vibration may be estimated and/or computed in the frequency domain based on the measured sound data and a pre-measured acoustic transfer function relating a set of acoustic (vibration) data captured under optimized conditions to a set of sound data. Use of sound and vibration enables a mutually complementary analysis that covers both overall condition analysis and part specific analysis. The optimized conditions may include operating a number of speakers at the vibration monitoring points associated with a number of acoustic sensors (e.g., volume acceleration sensor) during a quiet time (e.g., during a non-working or down time such as after workers leave and/or when machines are turned off). The acoustic data may be measured by one or more microphones at a set of one or more locations to capture one or more sets of acoustic data to generate one or more acoustic transfer functions at each of the set of one or more locations. In addition, the number of microphones used in the environment can be reduced as result of performing acoustic transfer function matrix operations. The reduced use of the microphones removes the costs associated with acoustic monitoring. For example, the number of microphones may be reduced as the same microphone(s) may be used to measure the acoustic transfer function for multiple monitored machines and the costs of operating the microphones may also be reduced or eliminated.

Example implementations described herein involve an innovative method and apparatus to utilize measured sound and estimated vibration, to perform monitoring for predictive maintenance. The sound may be monitored directly and the vibration may be monitored indirectly through the monitored sound. The vibration may be estimated and/or computed in the frequency domain based on the measured sound data and a pre-measured acoustic transfer function relating a set of acoustic data captured under optimized conditions. The optimized conditions may include operating a speaker at the vibration monitoring point associated with a particular acoustic sensor (e.g., volume acceleration sensor) in isolation during a quiet time (e.g., during a non-working or down time such as after workers leave and/or when machines are turned off). The acoustic data may be measured by one or more microphones at a set of one or more locations to capture multiple sets of acoustic data. Accordingly, acoustic sensors may be used for measuring the acoustic transfer function but not during a run-time or on a real-time basis. The reduced use of the acoustic sensors removes the costs associated with “full-time” acoustic monitoring. By using the complete 4 degrees of freedom (DOF) sound, this invention enables the standing wave node issue to be avoided. Additionally, when multiple sound sources have an identical acoustic frequency spectrum and position symmetry, each sound source can be identified using the 4 DOF sound and acoustic transfer functions.

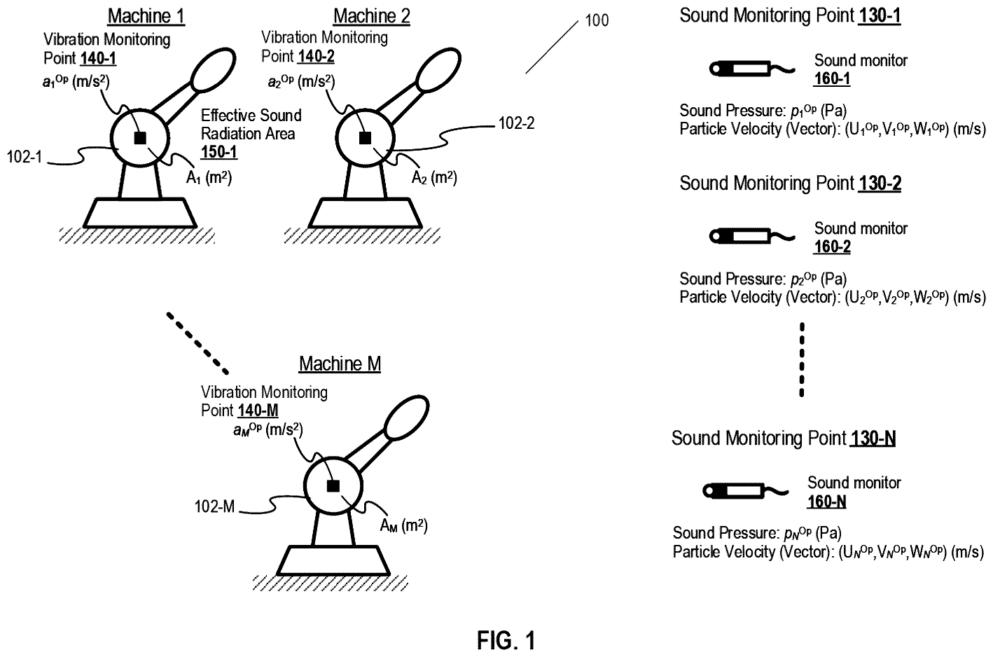

FIG. 1 illustrates an example diagram 100 of an environment for performing sound and vibration monitoring, in accordance with an example implementation. The diagram 100 illustrates a number of machines (machines 1-M′) to be monitored, and each machine may be represented by a robotic arm 102. A number of vibration monitoring points 140 (vibration monitoring points 140-1-M) on the robotic arms 102 are defined for the purpose of vibration monitoring. The vibration associated with the monitoring location on each robotic arm 102 may be associated with a sound radiation area.

The robotic arms 102 are monitored by a number of sound monitors 160-1-N (e.g., microphones). Sound monitoring may be associated with sound monitoring points 130 (sound monitoring points 130-1-N) and performed by the number of sound monitors 160-1-N installed at the sound monitoring points 130-1-N. M represents the number of sound sources, while N represents the number of sound monitoring points.

The sound monitoring point may be associated with a data set including a pressure P^{Op} (e.g., a sound pressure during operation (Op) measured in Pa) and a particle velocity vector V^{Op} including a set of vector components

$$( e . g . , {V}_{x}^{Op} , {V}_{y}^{Op} , {V}_{z}^{Op} )$$

(measured in m/s). In some example implementations, the sound monitors 160-1-N are positioned asymmetrically with respect to the robotic arms 102-1-M. This is performed to avoid singularity of generated acoustic transfer function matrices, which will be described in more detail below. In some example implementations, one or more machine parts/components of each machine is monitored for predictive maintenance.

The disclosure enables monitoring vibration and sound for machineries or a structure by monitoring sound only. The disclosure describes a method and apparatus that saves the costs incurred by monitoring by accelerometers while maintaining the operational efficiency using both vibration and sound for monitoring. Vibration is monitored, in some aspects, through estimation.

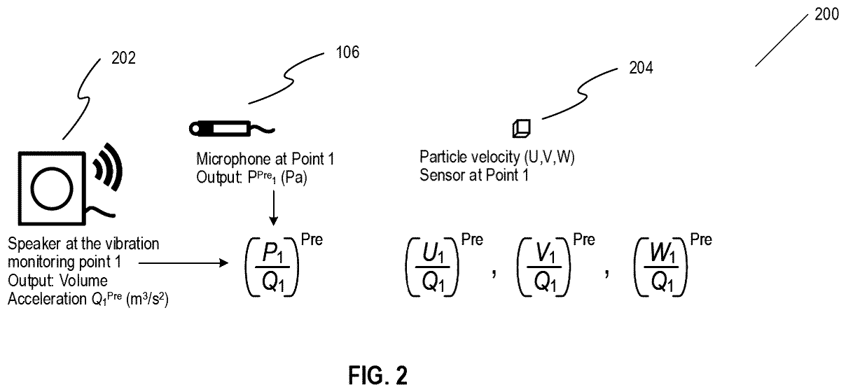

FIG. 2 illustrates an example diagram 200 of an environment for measuring an acoustic transfer function that relates sound (and/or vibration) at a monitored machine to a measured sound (e.g., pressure and/or particle velocity) at a particular point in the environment of the monitored machine, in accordance with an example implementation. A speaker 202 is associated with a robotic arm 102 at a vibration monitoring point 140. The measuring of the acoustic transfer function may be done at a quiet time, e.g., at a time when machines are not running and ambient noise is low such as at night. The quiet time may be a time period preceding a time period during which monitoring for predictive maintenance is performed. The speaker 202 may, at the quiet time, be operated at the vibration monitoring point 140 to produce sound at a range of frequencies (e.g., sine sweep sound, random noise, etc.). In some aspects, the produced sound may be associated with known values and/or collected data regarding a sound amplitude (and phase) as a function of time or frequency. When sound (P, U, V, W and Q) is a function of time, it has only amplitude is present. When sound is a function of frequency ω, both amplitude and phase are present. For example:

$$Q ( ω ) ) = \vert Q ( ω ) \vert cos ( φ ( ω ) ) ) , where \vert Q \vert represents amplitude and φ represents phase$$

At step one, a sound monitor 160 and a particle velocity sensor 204 positioned at a measurement location (e.g., Point 1) are used to collect one or more of sound pressure data (e.g., P^{Pre}) and a three-dimensional (3D) particle velocity vector

$$( {V}_{x}^{P r e} , {V}_{y}^{P r e} , {V}_{z}^{P r e} )$$

(where (Vₓ, V_{y}, V_{z})=(Uₙ, Vₙ, Wₙ)(m/s)) related to the volume acceleration data associated with the operation of the speaker 202. In some example implementations, sound pressure data and particle velocity data measurement/sampling and collection at the various measurement locations are performed in sequence. The superscript “Pre” indicates quantity measured prior to the machine operation monitoring (pre-measured). Volume acceleration Qₘ(m³/s²) can be measured directly by a volume acceleration sensor installed in the speaker 202.

In some example implementations, particle velocity data can be calculated from a set of sound pressure data using microphone distance data. One-dimensional particle velocity can be measured by two microphones with a fixed distance. Therefore, at least four microphones are necessary to compute and generate a 3D particle velocity vector. In this case, the number of computed particle velocity data (N′) is less than the number of measured sound pressure data N.

In some example implementations, normal vibration (e.g., acceleration aₘ) can be measured at the vibration monitoring point by a vibration sensor (e.g., accelerometer), which is useful in effective sound radiation area derivation. This is described in more detail below.

At step two, a Fast Fourier Transform (FFT) is then performed to convert the time domain data into the frequency domain data. This in turn generates the acoustic transfer functions (premeasured acoustic transfer functions) for sound pressure (Pₙ/Qₘ) and particle velocity vector (Uₙ,/Qₘ, Vₙ/Qₘ, Wₙ/Qₘ) where n=1, . . . , N (or N′ for particle velocity data). Therefore, a single measurement is able to generate 4N (representing N+3N′) measurements using the acoustic transfer functions.

At step three, the speaker 202 is moved to other measurement locations, and steps one and two are repeated at the measurement locations. Specifically, steps one and two are performed at all vibration monitoring points M to obtain measurements associated with all vibration monitoring points 1 . . . M. This in turn generates measurements for 4N*M (or (N+3N′)*M) acoustic transfer functions.

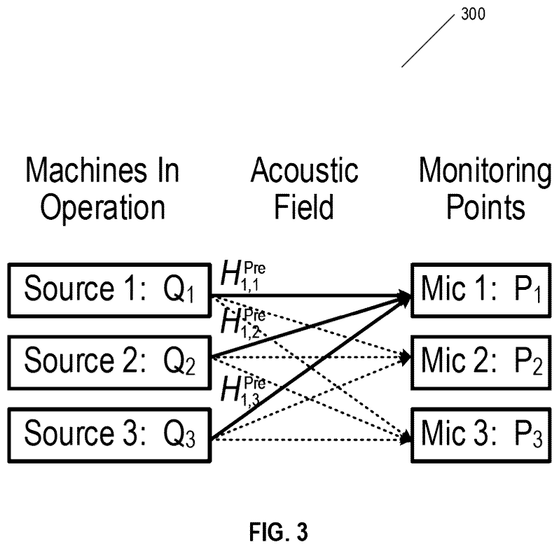

FIG. 3 illustrates an example network 300 with multiple sound sources and sound monitoring points, in accordance with an example implementation. The superscript “Op” indicates a quantity measured during machine operation. The relationship between the sound sources and sound monitoring points is shown in Eq. (1):

$${P}_{1}^{O p} = {H}_{1 , 1}^{Pre} {Q}_{1}^{O p} + {H}_{1 , 2}^{Pre} {Q}_{2}^{O p} + {H}_{1 , 3}^{Pre} {Q}_{3}^{O p} \qquad ( 1 )$$

As illustrated in FIG. 3, the network 300 may include multiple sound sources

$$( {Q}_{1}^{O p} , {Q}_{2}^{O p} , {Q}_{3}^{O p} )$$

and multiple sound monitoring points

$$( {P}_{1}^{O p} , {P}_{2}^{O p} , {P}_{3}^{O p} ) .$$

The acoustic transfer functions between the multiple sound sources and the multiple sound monitoring points can be expressed as

$${P}_{n} / {Q}_{m} = {H}_{n , m}^{Pre} .$$

The acoustic transfer functions are measured for all the combinations of defined vibration and sound monitoring points, which results in a matrix. The matrix can be expressed as shown below in Eq. (2), where Pₙ/Qₘ=H_{n,m}.

$${( \begin{matrix}\frac{{P}_{1}}{{Q}_{1}} & … & \frac{{P}_{1}}{{Q}_{M}} \\ ⋮ & ⋱ & ⋮ \\ \frac{{P}_{N}}{{Q}_{1}} & … & \frac{{P}_{N}}{{Q}_{M}}\end{matrix} )}_{N \times M}^{Pre} = {( \begin{matrix}{H}_{1 , 1} & … & {H}_{1 , M} \\ ⋮ & ⋱ & ⋮ \\ {H}_{N , 1} & … & {H}_{N , M}\end{matrix} )}_{N \times M}^{Pre} \qquad ( 2 )$$

Particle velocity transfer functions matrices are shown in Eq. (3).

$${( \begin{matrix}\frac{{U}_{1}}{{Q}_{1}} & … & \frac{{U}_{1}}{{Q}_{M}} \\ ⋮ & ⋱ & ⋮ \\ \frac{{U}_{{N}^{′}}}{{Q}_{1}} & … & \frac{{U}_{{N}^{′}}}{Q}\end{matrix} )}_{{N}^{′} \times M}^{Pre} , {( \begin{matrix}\frac{{V}_{1}}{{Q}_{1}} & … & \frac{{V}_{1}}{{Q}_{M}} \\ ⋮ & ⋱ & ⋮ \\ \frac{{V}_{{N}^{′}}}{{Q}_{1}} & … & \frac{{V}_{{N}^{′}}}{{Q}_{M}}\end{matrix} )}_{{N}^{′} \times M}^{Pre} , \qquad ( 3 )$$

$${( \begin{matrix}\frac{{W}_{1}}{{Q}_{1}} & … & \frac{{W}_{1}}{{Q}_{M}} \\ ⋮ & ⋱ & ⋮ \\ \frac{{W}_{{N}^{′}}}{{Q}_{1}} & … & \frac{{W}_{{N}^{′}}}{{Q}_{M}}\end{matrix} )}_{{N}^{′} \times M}^{Pre}$$

N′ is used in Eq. (3) for particle velocity instead of N. When particle velocity is directly measured at all the N points, N′ equals N.

When the machines are in operation, sound can be measured by the installed sound monitors 160 to obtain sound pressure and particle velocity data. During monitoring, data can be collected and accumulated over time to generate the complete four degrees of freedom (DOF) sound data (sound pressure P and particle velocity vector U, V, W). The four DOF sound data can be used in predictive maintenance. In some example implementations, partial data of the four DOF sound data would be sufficient in performing predictive maintenance (e.g., two DOF sound data may work well in certain situations).

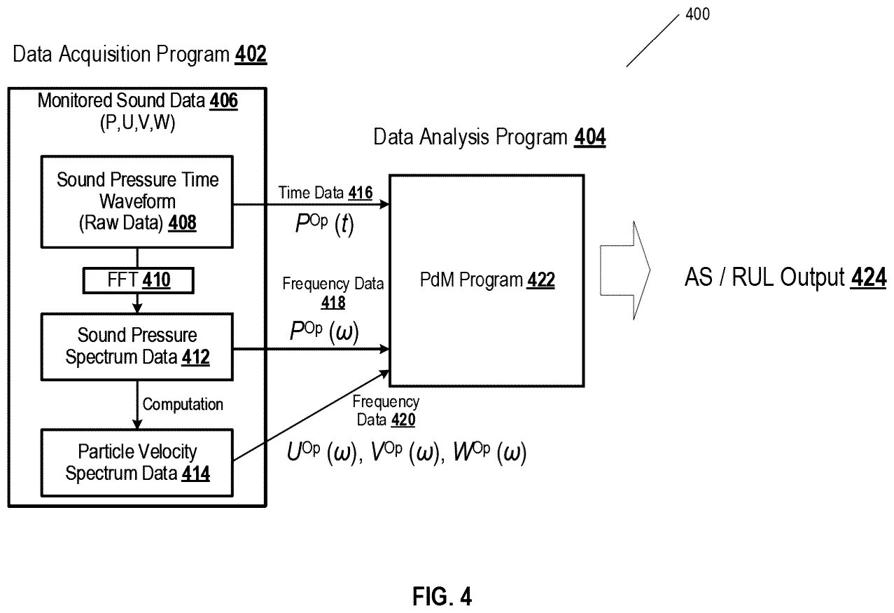

FIG. 4 illustrates an example diagram 400 for acquiring sound data and using the sound data for performing predictive maintenance, in accordance with an example implementation. Diagram 400 may include a data acquisition program 402 and a data analysis program 404. The data acquisition program 402 captures monitored sound data 406, which includes (P, U, V, W). Capturing the monitored sound data 406, in some aspects, includes capturing the monitored sound data 406 via a sound monitor 160 (e.g., sound microphone) at a monitoring point.

The monitored sound data 406 may include raw waveform data 408 (e.g., sound pressure over time) that includes sound data over time for each of the four degrees of freedom. The raw waveform data 408 may be processed by a Fast Fourier Transform (FFT) 410 to produce frequency domain data, sound pressure spectrum data 412. If particle velocity is not measured directly by a sensor, particle velocity spectrum data 414 can then be computed from the sound pressure spectrum data 412. The time-domain data 416 (e.g., a sound pressure P^{Op}(t)), the frequency-domain data 418 (e.g., a sound pressure P^{Op}(ω)), and the frequency-domain data 420 (e.g., particle velocity vector (U^{Op}(ω), V^{Op}(ω), W^{Op}(ω)) may be provided to the data analysis program 404 (or a predictive maintenance program/predetermined maintenance program (PdM program) 422) for a predictive maintenance operation based on the sound data (e.g., at least one of time-domain data 416, frequency-domain data 418, or frequency-domain data 420) to produce anomaly score (AS)/remaining useful life (RUL) output 424 for predictive maintenance. Only sound pressure data can be time domain data. Even when particle velocity is directly measured, this is typically expressed in frequency-domain data due to frequency-dependent calibration.

In some example implementations, the data analysis program 404 utilizes a trained machine learning (ML) and/or deep leaning (DL) technology/model in deriving AS/RUL output 424. Specifically, the PdM program 422 may utilize ML/DL in performing far-field sound analysis to capture main or outstanding sound characteristics.

Using the four DOF sound data and the acoustic transfer functions, the volume accelerations can then be computed. When there are multiple sound sources at the position 1, . . . M, the relational expression for a monitoring position 1 is given as:

$${P}_{1}^{O p} = {H}_{1 , 1}^{Pre} {Q}_{1}^{O p} + {H}_{1 , 2}^{Pre} {Q}_{2}^{O p} + … + {H}_{1 , M}^{Pre} {Q}_{M}^{O p} \qquad ( 4 )$$

For sound monitoring points 1, . . . N, the relation can be expressed as a matrix:

$${( \begin{matrix}{P}_{1} \\ ⋮ \\ {P}_{N}\end{matrix} )}_{N \times 1}^{Op} = {( \begin{matrix}{P}_{1} / {Q}_{1} & … & {P}_{1} / {Q}_{M} \\ ⋮ & ⋱ & ⋮ \\ {P}_{N} / {Q}_{1} & … & {P}_{N} / {Q}_{M}\end{matrix} )}_{N \times M}^{Pre} {( \begin{matrix}{Q}_{1} \\ ⋮ \\ {Q}_{M}\end{matrix} )}_{M \times 1}^{Op} = {( \begin{matrix}{H}_{1 , 1} & … & {H}_{1 , M} \\ ⋮ & ⋱ & ⋮ \\ {H}_{N , 1} & … & {H}_{N , M}\end{matrix} )}_{N \times M}^{Pre} {( \begin{matrix}{Q}_{1} \\ ⋮ \\ {Q}_{M}\end{matrix} )}_{M \times 1}^{Op} \qquad ( 5 )$$

Each particle velocity component (U, V, W) can be expressed as:

$${( \begin{matrix}{U}_{1} \\ ⋮ \\ {U}_{{N}^{′}}\end{matrix} )}_{{N}^{′} \times 1}^{Op} = {( \begin{matrix}{U}_{1} / {Q}_{1} & … & {U}_{1} / {Q}_{M} \\ ⋮ & ⋱ & ⋮ \\ {U}_{{N}^{′}} / {Q}_{1} & … & {U}_{{N}^{′}} / {Q}_{M}\end{matrix} )}_{{N}^{′} \times M}^{Pre} {( \begin{matrix}{Q}_{1} \\ ⋮ \\ {Q}_{M}\end{matrix} )}_{M \times 1}^{Op} \qquad ( 6 )$$

$${( \begin{matrix}{V}_{1} \\ ⋮ \\ {V}_{{N}^{′}}\end{matrix} )}_{{N}^{′} \times 1}^{Op} = {( \begin{matrix}{V}_{1} / {Q}_{1} & … & {V}_{1} / {Q}_{M} \\ ⋮ & ⋱ & ⋮ \\ {V}_{{N}^{′}} / {Q}_{1} & … & {V}_{{N}^{′}} / {Q}_{M}\end{matrix} )}_{{N}^{′} \times M}^{Pre} {( \begin{matrix}{Q}_{1} \\ ⋮ \\ {Q}_{M}\end{matrix} )}_{M \times 1}^{Op} \qquad ( 7 )$$

$${( \begin{matrix}{W}_{1} \\ ⋮ \\ {W}_{{N}^{′}}\end{matrix} )}_{{N}^{′} \times 1}^{Op} = {( \begin{matrix}{W}_{1} / {Q}_{1} & … & {W}_{1} / {Q}_{M} \\ ⋮ & ⋱ & ⋮ \\ {W}_{{N}^{′}} / {Q}_{1} & … & {W}_{{N}^{′}} / {Q}_{M}\end{matrix} )}_{{N}^{′} \times M}^{Pre} {( \begin{matrix}{Q}_{1} \\ ⋮ \\ {Q}_{M}\end{matrix} )}_{M \times 1}^{Op} \qquad ( 8 )$$

Based on equations (5)-(8), the volume accelerations

$$( {Q}_{1}^{O p} , … , {Q}_{M}^{O p} )$$

can be computed by a matrix operation. When N=M, the transfer function matrix is simply inversed. When N≠M (typically N<M), the pseudo-inverse of the matrix is computed. There are, at least, two ways to perform inversing (pseudo-inversing) of the matrix.

Under the first matrix inversing/pseudo-inversing method, each acoustic transfer function matrix is pseudo-inversed.

$${( \begin{matrix}{Q}_{1} \\ ⋮ \\ {Q}_{M}\end{matrix} )}_{M \times 1}^{Op} = {( \begin{matrix}{P}_{1} / {Q}_{1} & … & {P}_{1} / {Q}_{M} \\ ⋮ & ⋱ & ⋮ \\ {P}_{N} / {Q}_{1} & … & {P}_{N} / {Q}_{M}\end{matrix} )}_{N \times M}^{{Pre}^{†}} {( \begin{matrix}{P}_{1} \\ ⋮ \\ {P}_{N}\end{matrix} )}_{N \times 1}^{Op} \qquad ( 9 )$$

$${( \begin{matrix}{Q}_{1} \\ ⋮ \\ {Q}_{M}\end{matrix} )}_{M \times 1}^{Op} = {( \begin{matrix}{U}_{1} / {Q}_{1} & … & {U}_{1} / {Q}_{M} \\ ⋮ & ⋱ & ⋮ \\ {U}_{{N}^{′}} / {Q}_{1} & … & {U}_{{N}^{′}} / {Q}_{M}\end{matrix} )}_{{N}^{′} \times M}^{{Pre}^{†}} {( \begin{matrix}{U}_{1} \\ ⋮ \\ {U}_{{N}^{′}}\end{matrix} )}_{{N}^{′} \times 1}^{Op} \qquad ( 10 )$$

$${( \begin{matrix}{Q}_{1} \\ ⋮ \\ {Q}_{M}\end{matrix} )}_{M \times 1}^{Op} = {( \begin{matrix}{V}_{1} / {Q}_{1} & … & {V}_{1} / {Q}_{M} \\ ⋮ & ⋱ & ⋮ \\ {V}_{{N}^{′}} / {Q}_{1} & … & {V}_{{N}^{′}} / {Q}_{M}\end{matrix} )}_{{N}^{′} \times M}^{{Pre}^{†}} {( \begin{matrix}{V}_{1} \\ ⋮ \\ {V}_{{N}^{′}}\end{matrix} )}_{{N}^{′} \times 1}^{Op} \qquad ( 11 )$$

$${( \begin{matrix}{Q}_{1} \\ ⋮ \\ {Q}_{M}\end{matrix} )}_{M \times 1}^{Op} = {( \begin{matrix}{W}_{1} / {Q}_{1} & … & {W}_{1} / {Q}_{M} \\ ⋮ & ⋱ & ⋮ \\ {W}_{{N}^{′}} / {Q}_{1} & … & {W}_{{N}^{′}} / {Q}_{M}\end{matrix} )}_{{N}^{′} \times M}^{{Pre}^{†}} {( \begin{matrix}{W}_{1} \\ ⋮ \\ {W}_{{N}^{′}}\end{matrix} )}_{{N}^{′} \times 1}^{Op} \qquad ( 12 )$$

Dagger † indicates pseudo-inverse for N≠M, or indicates inverse for N=M. The superscript T and −1 indicate matrix transpose and inverse, respectively.

When the matrix rank(H)=N (or N′)<M, or (number of sound sensors)<(number of sound sources),

$${H}^{†} = {{H}^{T} ( H {H}^{T} )}^{- 1} \qquad ( 13 )$$

When the matrix rank(H)=M<N (or N′), or (number of sound sources)<(number of sound sensors):

$${H}^{†} = {( {H}^{T} H )}^{- 1} {H}^{T} \qquad ( 14 )$$

In some example implementations, each of the computed

$${Q}_{1}^{O p} , … , {Q}_{M}^{O p}$$

by Eqs. (9)-(12) may be averaged using linear averaging or weighted averaging.

It is assumed that HH^{T} is not singular for Eq. (13), and that H^{T}H is not singular for Eq. (14). Additionally, it is also assumed that HH^{†}=I for Eq. (13), and H^{†}H=I for Eq. (14), where I is a unit matrix. The microphone (sound monitor 160) positions need to be determined, such that the acoustic transfer function matrices above, e.g., HH^{†} (or H^{T} H), are invertible and not singular. Mathematically, when H is full column rank, then rank(H) equals to M (rank(H)=M). When H is full row rank, then rank(H) equals to N (rank(H)=N).

Under the second matrix inversing/pseudo-inversing method, the total acoustic transfer function matrix is pseudo-inversed as shown below:

$${( \begin{matrix}{Q}_{1} \\ ⋮ \\ {Q}_{M}\end{matrix} )}_{M \times 1}^{Op} = {( \begin{matrix}{P}_{1} / {Q}_{1} & … & {P}_{1} / {Q}_{M} \\ ⋮ & ⋱ & ⋮ \\ {P}_{N} / {Q}_{1} & … & {P}_{N} / {Q}_{M} \\ {U}_{1} / {Q}_{1} & … & {U}_{1} / {Q}_{M} \\ ⋮ & ⋱ & ⋮ \\ {U}_{{N}^{′}} / {Q}_{1} & … & {U}_{{N}^{′}} / {Q}_{M} \\ {V}_{1} / {Q}_{1} & … & {V}_{1} / {Q}_{M} \\ ⋮ & ⋱ & ⋮ \\ {V}_{{N}^{′}} / {Q}_{1} & … & {V}_{{N}^{′}} / {Q}_{M} \\ {W}_{1} / {Q}_{1} & … & {W}_{1} / {Q}_{M} \\ ⋮ & ⋱ & ⋮ \\ {W}_{{N}^{′}} / {Q}_{1} & … & {W}_{{N}^{′}} / {Q}_{M}\end{matrix} )}_{( N + 3 {N}^{′} ) \times M}^{{†}_{Pre}} \text{} {( \begin{matrix}{P}_{1} \\ ⋮ \\ {P}_{N} \\ {U}_{1} \\ ⋮ \\ {U}_{{N}^{′}} \\ {V}_{1} \\ ⋮ \\ {V}_{{N}^{′}} \\ {W}_{1} \\ ⋮ \\ {W}_{{N}^{′}}\end{matrix} )}_{( N + 3 {N}^{′} ) \times 1}^{Op} \qquad ( 15 )$$

Depending on each situation, the user can select an optimal

$${Q}_{m}^{Op}$$

to use for each

$${Q}_{m}^{Op} ( m = 1 , … , M ) .$$

In the situation where there is only a single sound source at a position 1, the volume acceleration

$${Q}_{1}^{Op}$$

can be computed without a matrix operation as:

$${Q}_{1}^{Op} = ( ω ) = \frac{{P}_{1}^{Op} ( ω )}{{H}_{1 , 1}^{P r e} ( ω )} ( = \frac{{P}_{2}^{Op} ( ω )}{{H}_{2 , 1}^{P r e} ( ω )} = … = \frac{{P}_{N}^{Op} ( ω )}{{H}_{N , 1}^{P r e} ( ω )} ) \qquad ( 16 )$$

The subscript 1 of Q indicates the sound source at position 1. This is based on the relationship:

$${P}_{𝓃}^{Op} = {H}_{𝓃 , 1}^{Pre} {Q}_{1}^{Op} .$$

Eq. (16) for P is true for each particle velocity component (U, V, W).

$${Q}_{1}^{Op} ( ω ) = \frac{{U}_{n}^{Op} ( ω )}{{( {U}_{n} / {Q}_{1} )}^{P r e} ( ω )} = \frac{{V}_{n}^{Op} ( ω )}{{( {V}_{n} / {Q}_{1} )}^{P r e} ( ω )} = \frac{{W}_{n}^{Op} ( ω )}{{( {W}_{n} / {Q}_{1} )}^{P r e} ( ω )} , n = 1 , … , {N}^{′} \qquad ( 17 )$$

The number of computed

$${Q}_{1}^{Op}$$

is N in Eq. (16), while the number of computed

$${Q}_{1}^{Op}$$

is 3 N′ in Eq. (17). The final value of

$${Q}_{1}^{Op}$$

(to be used in sound source contribution analysis) may be an averaged value of these computed

$${Q}_{1}^{Op} .$$

Eq. (4) indicates that sound pressure

$${P}_{n}^{Op} ( ω )$$

is expressed as a summation of each sound source contribution. For example, a term

$${H}_{1 , 𝓂}^{Pre} {Q}_{𝓂}^{Op} = {P}_{1 , 𝓂}^{Op} ( ω )$$

is the contribution of source m to the sound pressure at position 1.

$$\begin{matrix}{P}_{n}^{Op} ( 𝓌 ) = {H}_{𝓃 , 1}^{P r e} {Q}_{1}^{Op} + {H}_{𝓃 , 2}^{P r e} {Q}_{2}^{Op} + … + {H}_{𝓃 , M}^{P r e} {Q}_{M}^{{O}_{P}} \\ = {P}_{𝓃 , 1}^{Op} ( ω ) + {P}_{𝓃 , 2}^{Op} ( ω ) + … + {P}_{𝓃 , M}^{Op} ( ω )\end{matrix} \qquad ( 18 )$$

$$𝓃 = 1 , … , N$$

The sound pressure decomposition Eqs. (4) and (18) enable the performance of sound source contribution analysis. For example, when sound

$${P}_{𝓃}^{Op} ( ω )$$

becomes noisy at a microphone location n, each contributed sound source

$$( {P}_{𝓃 , 1}^{Op} , … , {P}_{𝓃 , M}^{Op} )$$

is quantified, and the cause (the highest contributing sound source) is identified by comparing the amplitudes of the terms in Eq. (18).

The same contribution analysis can also be applied to particle velocity:

$$\{ \begin{matrix}{U}_{n}^{Op} ( ω ) = {( {U}_{n} / {Q}_{1} )}^{Pre} {Q}_{1}^{Op} + ⋯ + {( {U}_{n} / {Q}_{M} )}^{Pre} {Q}_{M}^{Op} = {U}_{n , 1}^{Op} + ⋯ + {U}_{n , M}^{Op} \\ {V}_{n}^{Op} ( ω ) = {( {V}_{n} / {Q}_{1} )}^{Pre} {Q}_{1}^{Op} + ⋯ + {( {V}_{n} / {Q}_{M} )}^{Pre} {Q}_{M}^{Op} = {V}_{n , 1}^{Op} + ⋯ + {V}_{n , M}^{Op} \text{} \\ {W}_{n}^{Op} ( ω ) = {( {W}_{n} / {Q}_{1} )}^{Pre} {Q}_{1}^{Op} + ⋯ + {( {W}_{n} / {Q}_{M} )}^{Pre} {Q}_{M}^{Op} = {W}_{n , 1}^{Op} + ⋯ + {W}_{n , M}^{Op}\end{matrix} \qquad ( 19 )$$

$$n = 1 , … , N$$

With the particle velocity being a vector, contribution analysis can be performed using both the particle velocity components (U, V, W) individually, as well as the vector magnitude

$$\sqrt{{U}_{n , m}^{2} + {V}_{n , m}^{2} + {W}_{n , m}^{2}} .$$

When the vector magnitude is used, the phase differences among the three components should be taken into consideration.

The computed volume accelerations

$${Q}_{1}^{Op} , … , {Q}_{M}^{Op}$$

are related to the structural normal acceleration (vibration)

$${a}_{1}^{Op} , … , {a}_{M}^{Op} .$$

This relationship is shown in:

$${a}_{m}^{Op} ( ω ) = \frac{{Q}_{m}^{Op} ( ω )}{{A}_{m} ( ω )} , ( m = 1 , … , M ) \qquad ( 20 )$$

Aₘ(ω) is the effective sound radiation area (effective radiation area) of the structure, and

$${a}_{m}^{Op} ( m / {s}^{2} )$$

is the normal acceleration perpendicular to the structural surface. The effective area can be a constant Aₘ or frequency-dependent Aₘ(a). To estimate the effective area Aₘ, the simplest way is through performance of main physical surface area estimation of the sound source. To obtain a more accurate effective area, a vibration sensor (e.g., accelerometer) is used to measure the structural normal acceleration

$${a}_{m}^{Pre} ( ω )$$

when the volume acceleration source is operated to measure the acoustic transfer function. This area is typically a frequency-dependent Aₘ(ω).

$${A}_{m} ( ω ) = \frac{{Q}_{m}^{P r e} ( ω )}{{a}_{m}^{P r e} ( ω )} , ( m = 1 , … , M ) \qquad ( 21 )$$

In alternate example implementations, the effective area can be estimated using a vibration shaker to excite the vibration monitoring point m. Then, the normal acceleration

$${a}_{m}^{Pre} ( ω )$$

and volume acceleration

$${Q}_{m}^{Pre} ( ω )$$

can be measured, and Eq. (21) can be used in deriving Aₘ(ω).

A vibration shaker is often used (or equipped) with a force sensor to measure the excitation force. In alternate example implementations, the excitation force

$${F}_{m}^{Pre} ( ω )$$

and sound pressure

$${P}_{m}^{Pre} ( ω )$$

at the point m (using another sound monitor 160 such as a microphone) can be measured to obtain Aₘ(ω).

$${A}_{m} ( ω ) = \frac{{Q}_{m}^{P r e} ( ω )}{{a}_{m}^{P r e} ( ω )} = \frac{{F}_{m}^{P r e} ( ω )}{{P}_{m}^{P r e} ( ω )} , ( m = 1 , … , M ) \qquad ( 22 )$$

The right-side equality of Eq. (22) is called the vibro-acoustic reciprocity principle.

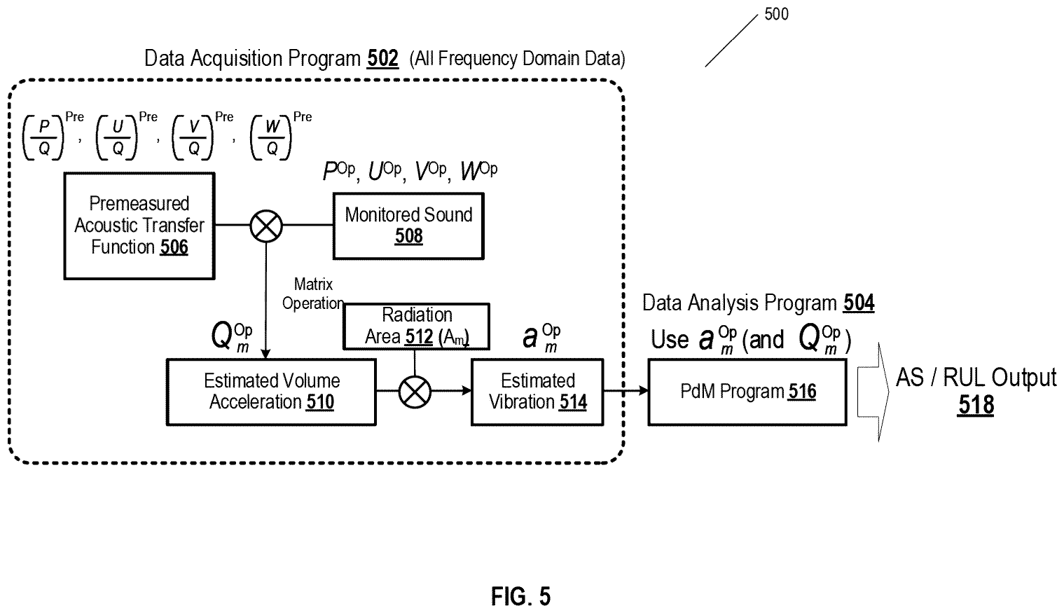

FIG. 5 illustrates an example diagram 500 for acquiring sound data and using the sound data for performing predictive maintenance, in accordance with an example implementation. Diagram 500 illustrates that a data acquisition program 502 may include components to combine pre-measured acoustic transfer functions 506 (in frequency-domain) and monitored sound data 508 (in frequency domain) to compute estimated volume accelerations 510

$$510 ( {Q}_{m}^{Op} )$$

through matrix operation. The estimated volume acceleration 510 and a frequency-dependent radiation area 512 are then used in conjunction in computing estimated vibration

$$514 ( {a}_{m}^{O p} ( ω ) ) .$$

Because the near-field volume acceleration

$${Q}_{m}^{O p} ( ω )$$

is closely tied with the structural normal vibration

$${a}_{m}^{O p} ( ω ) ,$$

the data characteristics of the near-field volume acceleration

$${Q}_{m}^{O p} ( ω )$$

are closer to characteristics of vibration data than acoustic data. Therefore, the volume acceleration 510 is employed in the vibration analysis program.

The estimated volume acceleration 510 and/or the estimated vibration 514 may be provided to a predictive maintenance program (PdM program) 516 of the data analysis program 504 to produce an AS/RUL output 518 for predictive maintenance for each vibration monitoring point m=1, 2, . . . , M. In some example implementations, the predictive maintenance program 516 may use one or more sets of programs including trained ML networks, deep learning programs, or other algorithms to produce the AS/RUL output 518.

In some example implementations, the PdM program 516 may be divided into two programs, one (PdM program A) for structural vibration

$${a}_{m}^{O p} ( ω ) ,$$

and the other (PdM program B) for near-field volume acceleration

$${Q}_{m}^{O p} ( ω ) .$$

ML/DL technologies may be employed by the two programs in performing analysis. By separating vibration data analysis from the near-field sound data analysis, the ML/DL programs sometimes may provide more accurate AS/RUL output 518. As result of which, three separate PdM programs are generated:
1. PdM program 422 for performing directly measured 4 DOF far-field sound (PₙUₙVₙWₙ)^{Op} analysis;
2. PdM program A of PdM program 516 for performing structural normal vibration

$${a}_{m}^{O p} ( ω )$$

analysis; and
3. PdM program B of PdM program 516 for performing near-field sound

$${Q}_{m}^{O p} ( ω )$$

analysis.

$${a}_{m}^{O p} ( ω ) and {Q}_{m}^{O p} ( ω )$$

become proportional when the effective area Aₘ is a non-frequency-dependent constant. This leads to the combination of the PdM programs A and B into a single PdM program 516 as shown in FIG. 5.

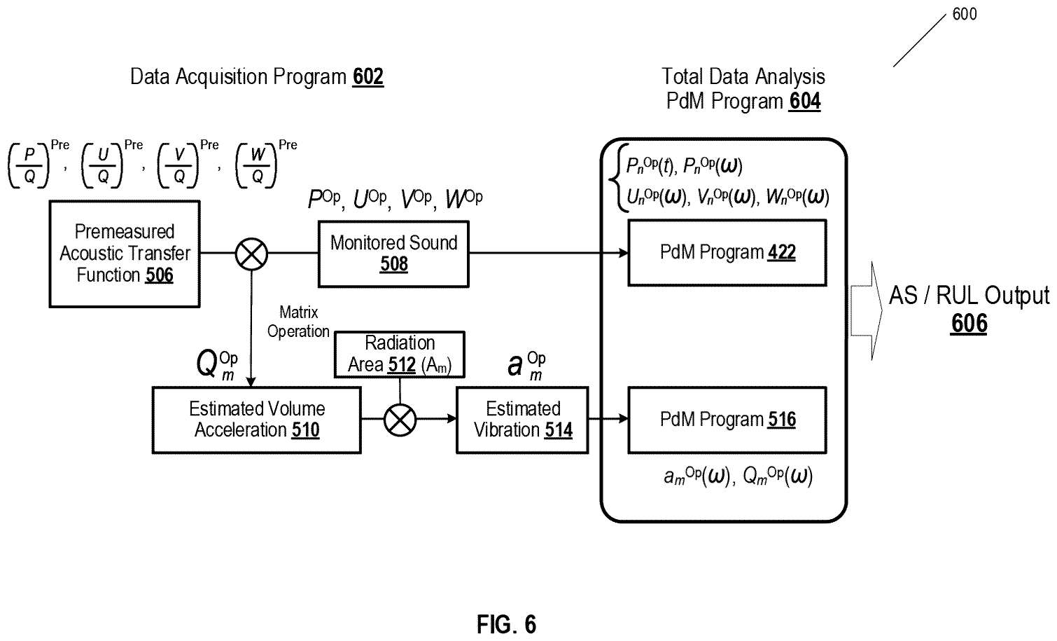

FIG. 6 illustrates an example diagram 600 for acquiring sound data and using the sound data for performing predictive maintenance, in accordance with an example implementation. Diagram 600 illustrates that a data acquisition program 602 may include components to combine pre-measured acoustic transfer functions 506 (in frequency-domain) and monitored sound data 508 (in frequency domain) to compute estimated volume accelerations

$$510 ( {Q}_{m}^{O p} )$$

through matrix operation. The estimated volume acceleration 510 and a frequency-dependent radiation area 512 are then used in conjunction in computing estimated vibration 514

$$514 ( {a}_{m}^{O p} ( ω ) ) .$$

As illustrated in FIG. 6, the total data analysis PdM program 604 may utilize both the PdM program 422 of FIG. 4 and PdM program 516 of FIG. 5. The total data analysis PdM program 604 utilizes both the measured four DOF sound data and computed vibration data to generate the AS/RUL output 606. In some example implementations, the total data analysis PdM program 604 may utilize ML/DL technologies in performing AS/RUL output 606 for predictive maintenance for each vibration monitoring point m=1, 2, . . . , M.

In alternate example implementations, the PdM program 604 may utilize one or more programs that differ from the PdM program 422 and/or the PdM program 516 in generating the AS/RUL output 606. For example, the PdM program 604 may utilize one or more programs using a subset of (P, U, W, Q) and (a, Q) in deriving the AS/RUL output 606.

The output quantities for the predictive maintenance are computed in three ways. The PdM program 422 computes the AS/RUL using the measured far-field 4 DOF sound quantities (PₙUₙVₙWₙ)^{Op} at the (N+3N′) points. The PdM program 516 computes the AS/RUL for each vibration monitoring point m=1, 2, . . . , M, using the estimated vibration quantities

$${a}_{m}^{O p} ( ω ) ,$$

which may include the near-field volume accelerations

$${Q}_{m}^{O p} ( ω ) ,$$

at the M points. The PdM program 604 computes the AS/RUL for each vibration monitoring point m=1, 2, . . . , M, using both the measured far-field 4 DOF sound data and the estimated vibration data (and the near-field volume accelerations, as well). Therefore, the PdM outputs may be computed in three different ways. In some alternate example implementations, the PdM program 516 may be further separated to create fourth and fifth ways of computing AS/RUL. Specifically, the fourth way uses only

$${a}_{m}^{O p} ( ω )$$

in performing structural vibration analysis, and the fifth way uses only

$${Q}_{m}^{O p} ( ω )$$

in performing near-field sound analysis.

Far-field sound data is ideal for finding the main or outstanding conditions of the machine, while vibration data (and near-field sound data) is ideal for finding the detail conditions near the sensor. Utilization of both data types allows the total data analysis PdM program 604 to provide a better AS/RUL result.

The foregoing example implementation may have various benefits and advantages. For example, full-time monitoring of both sound and vibration is achieved using only sound sensors. By removing full-time vibration sensors from the picture, costs associated with active monitoring are reduced. Issue of position symmetry is avoided through use of the complete four DOF sound data. For example, using only sound pressure data would create an identification issue when two machines are performing the same operation in symmetric positions. However, by using particle velocity vector, sounds can be distinguished using directional vectors.

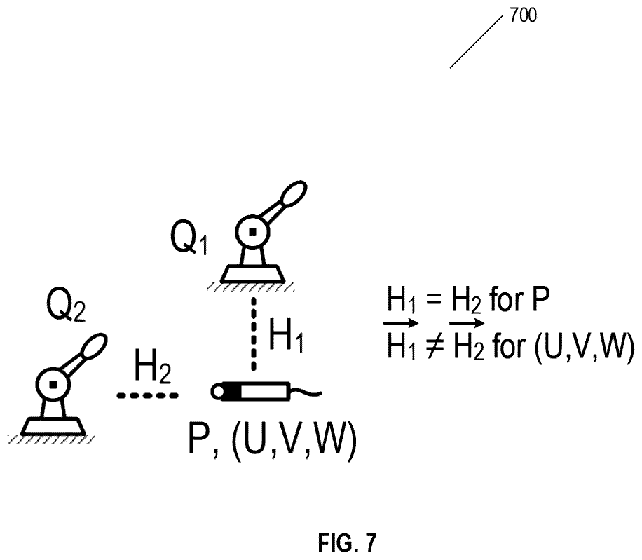

FIG. 7 illustrates an example diagram 700 for performing sound distinction, in accordance with an example implementation. A symmetry causes the same sound pressure transfer function H₁=H₂ for sound pressure P (scalar). However, through use of a particle velocity vector, Q₁ and Q₂ can be quantified and distinguished. Specifically, when sound pressure transfer functions are identical (e.g., H₁=H₂), the matrix in Eq. (9) becomes singular and cannot be inverted and hence, Q₁ and Q₂ cannot be computed. However, when H₁=H₂= . . . for P, one or more matrices in Eqs. (10), (11), and (12) does not become singular, and Q₁, Q₂, . . . can be computed accordingly. This is so because particle velocity takes the form of a vector.

By using the pseudo-inverse of the acoustic transfer function matrix, the number of sound sensors (e.g., microphones) can be less than the number of the sound sources (machines or machine parts) to monitor, which results in reduced monitoring expenditure.

If the sound monitoring point is placed at a node of a standing wave (for a particular frequency) of the room, sound pressure (e.g., P^{Op}) may be (close to) zero. Because nodes for sound pressure and the particle velocity are usually different and that either sound pressure or particle velocity is no-zero, by using both sound pressure and particle velocity, the standing wave node issue is avoided.

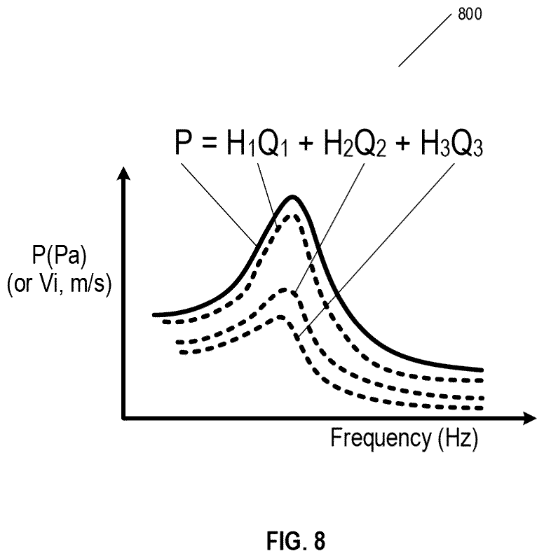

Sound source contribution identification is beneficial when same sound sources exist. FIG. 8 illustrates an example sound source contribution analysis 800, in accordance with an example implementation. As illustrated in FIG. 8, the sound sources 1, 2 and 3 peak at the same frequency. Q₁, Q₂ and Q₃ can be identified and derived by knowing H₁, H₂ and H₃. When the sound sources have different spectral characteristics, the number of microphones can be reduced by performing sound analysis (e.g., comparing FFT spectra). However, when the sound sources have same spectral characteristics, sound source contribution analysis may be performed utilizing Eqs. (18) and/or (19), instead of using a dedicated near-field microphone for each sound source.

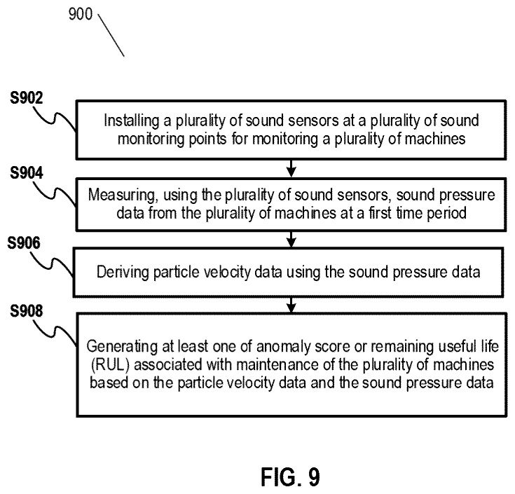

FIG. 9 illustrates an example process flow 900 for performing predictive maintenance, in accordance with an example implementation. The process begins at step S902 where a plurality of sound sensors are installed at a plurality of sound monitoring points for monitoring a plurality of machines. At step S904, sound pressure data is measured from the plurality of machines at a first time period using the sound sensors. At step S906, particle velocity data is derived using the sound pressure data. The process then continues to step S908 where at least one of anomaly score or remaining useful life (RUL) associated with maintenance of the plurality of machines is generated based on the particle velocity data and the sound pressure data.

The foregoing example implementations may have various benefits and advantages. For example, an unconventional way of vibration monitoring is achieved through directly monitored sound data and premeasured acoustic transfer function. Both vibration and sound (acoustic) data monitoring can be achieved through performance of only direct sound monitoring, which could not be achieved under related art. By estimating the vibration, the number of microphones used in the environment can be reduced, which reduces operational expenditures on microphones.

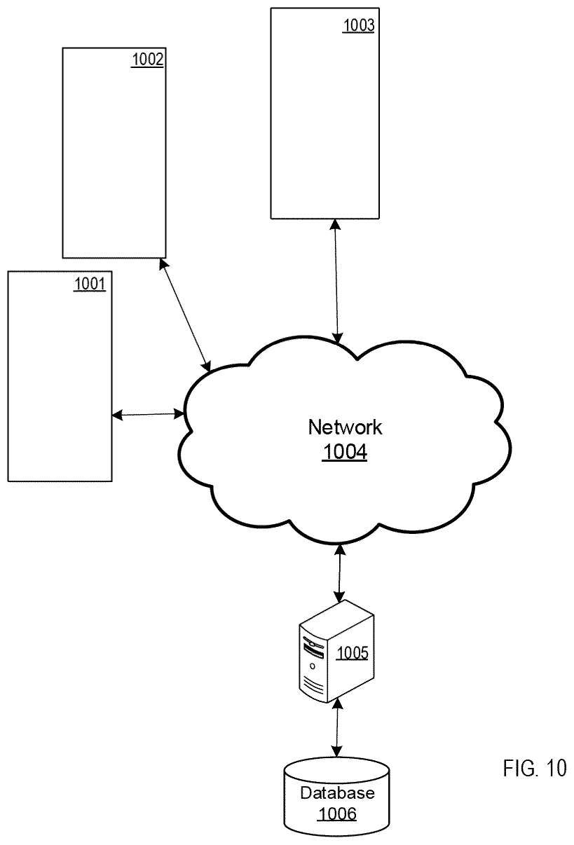

FIG. 10 illustrates a system involving a plurality of sensors, monitors, assets/industrial systems, computing devices, or machines networked to a management apparatus, in accordance with an example implementation. One or more monitors 1001, asset systems 1002, or machines 1003 are communicatively coupled to a network 1004 (e.g., local area network (LAN), wide area network (WAN)) through the corresponding on-board computer or Internet of Things (IoT) device of the monitors 1001, the asset systems 1002, or the machines 1003, which is connected to a management apparatus 1005. The management apparatus 1005 manages a database 1006, which contains historical data collected from the monitors 1001, the asset systems 1002, or the machines 1003 and also facilitates remote control to each of the assets in the monitors 1001, the asset systems 1002, the or machines 1003. In alternate example implementations, the data from the assets can be stored to a central repository or central database such as proprietary databases that intake data, or systems such as enterprise resource planning systems, and the management apparatus 1005 can access or retrieve the data from the central repository or central database. Asset systems 1002 can involve any physical system for use in a physical process such as an assembly line or production line, in accordance with the desired implementation, such as but not limited to air compressors, lathes, robotic arms, and so on in accordance with the desired implementation, and can also include an edge gateway that is configured to manage the underlying assets in the asset systems 1002. The data provided from the sensors of such assets can serve as the data flows as described herein upon which analytics can be conducted, and the data is transmitted form the sensors of the assets to the edge gateways in the asset systems 1002, whereupon such data can be processed with edge analytics or anomaly detection as described in the example implementations herein before management by the management apparatus 1005.

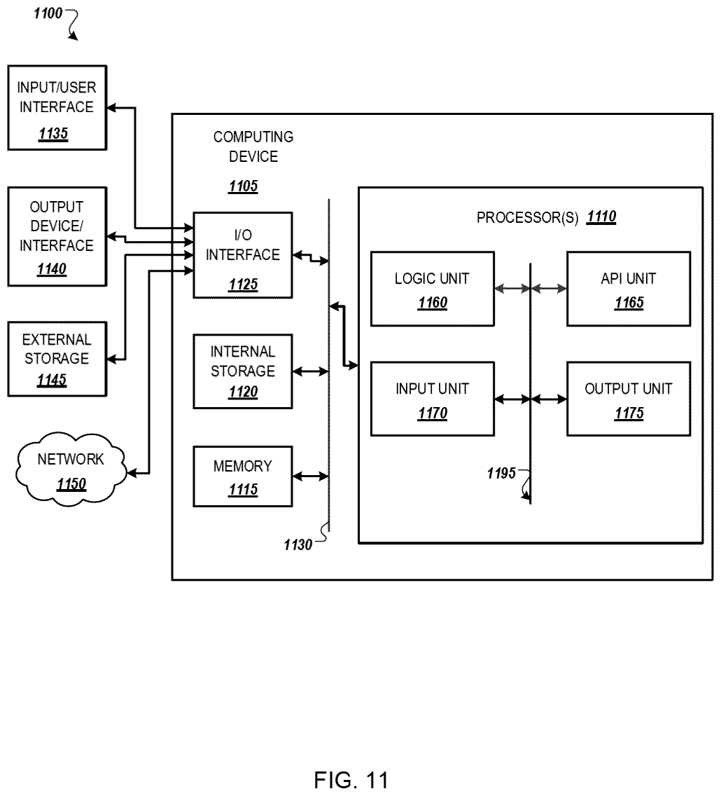

FIG. 11 illustrates an example computing environment with an example computer device suitable for use in some example implementations. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired implementation.

Computer device 1105 can be communicatively coupled to input/user interface 1135 and output device/interface 1140. Either one or both of the input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

I/O interface 1125 can include, but is not limited to, wired and/or wireless interfaces using any communication or I/O protocols or standards (e.g., Ethernet, 902.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, the input unit 1170, and the output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide an output based on the calculations described in example implementations.

Processor(s) 1110 can be configured to derive particle velocity data using the sound pressure data as shown in FIGS. 1, 2, and 4. The processor(s) 1110 can be configured to generate at least one of anomaly score or remaining useful life (RUL) associated with maintenance of the plurality of machines based on the particle velocity data and the sound pressure data as shown in FIGS. 1 and 4.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for performing predictive maintenance, the method comprising:
installing a plurality of sound sensors at a plurality of sound monitoring points for monitoring a plurality of machines;
measuring, using the plurality of sound sensors, sound pressure data from the plurality of machines at a first time period;
deriving, by a processor, particle velocity data using the sound pressure data; and
generating, by the processor, at least one of anomaly score or remaining useful life (RUL) associated with maintenance of the plurality of machines based on the particle velocity data and the sound pressure data,
wherein the particle velocity data is derived from the sound pressure data based on distance of the plurality of sound sensors, and
wherein the plurality of sound sensors are microphones.

2. The method of claim 1, wherein a number of the plurality of sound sensors is less than a number of the plurality of machines.

3. The method of claim 1, wherein the processor is configured to generate at least one of anomaly score or RUL by:
using the particle velocity data in frequency-domain and the sound pressure data in at least one of time-domain or frequency-domain as input to a predetermined maintenance program to generate at least one of anomaly score or RUL,
wherein the predetermined maintenance program is a trained machine learning model.

4. The method of claim 1, wherein the processor is configured to generate at least one of anomaly score or RUL by:
using the sound pressure data and the particle velocity data with premeasured acoustic transfer functions to obtain estimated volume acceleration;
estimating vibration information using the estimated volume acceleration and an effective radiation area; and
using the vibration information and the estimated volume acceleration as input to a predetermined maintenance program to generate at least one of anomaly score or RUL,
wherein the predetermined maintenance program is a trained machine learning model.

5. The method of claim 4, wherein the premeasured acoustic transfer functions are derived by:
operating, during a second time period preceding the first time period, a speaker at a plurality of locations for measuring the sound pressure data in sequence;
collecting, during the second time period, (1) sample sound pressure data associated with the speaker; (2) sample particle velocity data associated with the speaker; and (3) sample volume acceleration data associated with the speaker; and
calculating the premeasured acoustic transfer functions by dividing the sample sound pressure data and the sample particle velocity data against the sample volume acceleration data in frequency domain.

6. The method of claim 1, wherein the processor is configured to generate at least one of anomaly score or RUL by:
using the sound pressure data and the particle velocity data with premeasured acoustic transfer functions to obtain estimated volume acceleration;
estimating vibration information using the estimated volume acceleration and an effective radiation area; and
using the particle velocity data in frequency-domain, the sound pressure data in at least one of time-domain or frequency-domain, the vibration information, and the estimated volume acceleration as input to a predetermined maintenance program to generate at least one of anomaly score or RUL,
wherein the predetermined maintenance program is a trained machine learning model.

7. The method of claim 6, wherein the premeasured acoustic transfer functions are derived by:
operating, during a second time period preceding the first time period, a speaker at a plurality of locations for measuring the sound pressure data in sequence;
collecting, during the second time period, (1) sample sound pressure data associated with the speaker; (2) sample particle velocity data associated with the speaker; and (3) sample volume acceleration data associated with the speaker; and
calculating the premeasured acoustic transfer functions by dividing the sample sound pressure data and the sample particle velocity data against the sample volume acceleration data in frequency domain.

8. A system for performing predictive maintenance, the system comprising:
a plurality of machines;
a plurality of sound sensors, wherein the plurality of sound sensors are installed at a plurality of sound monitoring points for monitoring the plurality of machines; and
a processor in communication with the plurality of sound sensors, the processor is configured to:
measure sound pressure data from the plurality of machines at a first time period,
derive particle velocity data using the sound pressure data, and
generate at least one of anomaly score or remaining useful life (RUL) associated with maintenance of the plurality of machines based on the particle velocity data and the sound pressure data,
wherein the particle velocity data is derived from the sound pressure data based on distance of the plurality of sound sensors, and
wherein the plurality of sound sensors are microphones.

9. The system of claim 8, wherein a number of the plurality of sound sensors is less than a number of the plurality of machines.

10. The system of claim 8, wherein the processor is configured to generate at least one of anomaly score or RUL by:
using the particle velocity data in frequency-domain and the sound pressure data in at least one of time-domain or frequency-domain as input to a predetermined maintenance program to generate at least one of anomaly score or RUL,
wherein the predetermined maintenance program is a trained machine learning model.

11. The system of claim 8, wherein the processor is configured to generate at least one of anomaly score or RUL by:
using the sound pressure data and the particle velocity data with premeasured acoustic transfer functions to obtain estimated volume acceleration;
estimating vibration information using the estimated volume acceleration and an effective radiation area; and
using the vibration information and the estimated volume acceleration as input to a predetermined maintenance program to generate at least one of anomaly score or RUL,
wherein the predetermined maintenance program is a trained machine learning model.

12. The system of claim 11, wherein the premeasured acoustic transfer functions are derived by:
operating, during a second time period preceding the first time period, a speaker at a plurality of locations for measuring the sound pressure data in sequence;
collecting, during the second time period, (1) sample sound pressure data associated with the speaker; (2) sample particle velocity data associated with the speaker; and (3) sample volume acceleration data associated with the speaker; and
calculating the premeasured acoustic transfer functions by dividing the sample sound pressure data and the sample particle velocity data against the sample volume acceleration data in frequency domain.

13. The system of claim 8, wherein the processor is configured to generate at least one of anomaly score or RUL by:
using the sound pressure data and the particle velocity data with premeasured acoustic transfer functions to obtain estimated volume acceleration;
estimating vibration information using the estimated volume acceleration and an effective radiation area; and
using the particle velocity data in frequency-domain, the sound pressure data in at least one of time-domain or frequency-domain, the vibration information, and the estimated volume acceleration as input to a predetermined maintenance program to generate at least one of anomaly score or RUL,
wherein the predetermined maintenance program is a trained machine learning model.

14. The system of claim 13, wherein the premeasured acoustic transfer functions are derived by:
operating, during a second time period preceding the first time period, a speaker at a plurality of locations for measuring the sound pressure data in sequence;
collecting, during the second time period, (1) sample sound pressure data associated with the speaker; (2) sample particle velocity data associated with the speaker; and (3) sample volume acceleration data associated with the speaker; and
calculating the premeasured acoustic transfer functions by dividing the sample sound pressure data and the sample particle velocity data against the sample volume acceleration data in frequency domain.
